(19) United States
(12) Patent Application Publication
(10) Pub. No.: US 2008/0314415 A1
(43) Pub. Date: Dec. 25, 2008

(54) Cleaning Contaminated Materials

(75) Inventors: Nicholas John Crowther, Bradford (GB); Donald Eagland, Huddersfield (GB)

Correspondence Address: Scott A. McCollister;Fay, Sharpe, Fagan, Minnich & McKee, 1100 Superior Avenue, Seventh Floor, Cleveland, OH, 44114-2579, US

(73) Assignee: ADVANCED GEL TECHNOLOGY LIMITED, Bradford (GB)

(21) Appl. No.: 10/574,188

(22) PCT Filed: Sep. 28, 2004
(86) PCT No.: PCT/GB2004/004108

§ 371 Date: Sep. 16, 2008

(30) Foreign Application Priority Data
Oct. 2, 2003 (GB) 0323064.6

(51) Int. Cl. B08B 3/08

(52) U.S. Cl. 134/26

(57) ABSTRACT

Oil contaminated drill cuttings are contacted with an oil soluble surfactant with agitation which causes the hydrophobic moiety of the surfactant to interact with the oil. Next, an aqueous polymer formulation comprising a polymer having polar and/or ionic functionality is added and mixed. Then, an excess volume of water is added with gentle agitation and the mixture is allowed to settle, whereupon the cuttings sediment to the bottom of the receptacle in which the process is undertaken and the supernatant contains a colloidal suspension of particles which comprise oil, surfactant and polymer. The drill cuttings may then be separated from the supernatant by filtration. The supernatant may be treated with a flocculating agent to cause the colloidal particles to sediment. They too may then be separated.

This invention relates to cleaning contaminated materials and particularly, although not exclusively, relates to a method for cleaning a material, for example drill cuttings, contaminated with a hydrocarbon, for example oil.

Hydrocarbons such as crude oil and natural gas are recovered from wells or boreholes drilled deep into the earth. Conventionally, a borehole is drilled using a rotary drill bit on the end of a rotatable, hollow drill stem. A drilling fluid is pumped downwardly through the hollow drill stem to cool and lubricate the drill bit while at the same time carrying the cuttings upwardly through the annular space surrounding the drill stem. The drilling fluid and the cuttings are circulated to the surface where the cuttings are removed so that the drilling fluid can be recycled into the system. The cuttings are usually separated from most of the drilling fluid using vibrating screens known as shale shakers and centrifuges.

The cuttings retain a significant volume (up to 15 wt %) of drilling fluid (which is often water based and may incorporate chemicals) and/or oil (which may have broken through a region being drilled) on them after separation which must be removed so that the decontaminated drill cuttings incorporate less than the maximum environmentally acceptable level (less than 1 wt %) of oil. Cuttings of less than 1 wt % oil can be disposed of by, for example, discharge into the sea, burial in a landfill site, composting, bio-remediation, thermal desorption and combustion.

However, cleaning contaminated drill cuttings and reducing the level of oil to an acceptable level can be a difficult task. It is an object of the present invention to address this problem.

According to a first aspect of the present invention, there is provided a method of cleaning a contaminated material which comprises a solid material which is contaminated with a hydrocarbon, the method comprising the steps of:

(A) contacting the contaminated material with a surface active agent thereby to form a first mixture including said contaminated material and said surface active agent;
(B) contacting said first mixture with a carrier formulation to prepare a second mixture wherein said carrier formulation is arranged to interact with said surface active agent and/or said hydrocarbon;
(C) separating said solid material in said second mixture from other components in the second mixture, wherein said solid material which is separated contains a lower level of said hydrocarbon compared to that in said contaminated material contacted in step (A).

Said contaminated material contacted in the method preferably comprises drill cuttings which may be produced when drilling for oil or gas. The cuttings may comprise rock fragments.

Said contaminated material may be contaminated with a drilling fluid. Said contaminated material may be contaminated with petroleum, for example oil which may be a component of a said drilling fluid or may be released from a formation being drilled.

Said contaminated material may comprise at least 5 wt %, at least 8 wt % or even 10 wt % or more of fluidic hydrocarbon(s). The contaminated material may comprise the aforementioned amounts of oil. Usually, said contaminated material includes less than 20 wt % of fluidic hydrocarbon(s).

Step (A) of the method is preferably carried out above ground. In the method a mass of said contaminated material is selected and contacted with said surfactant. The ratio of the wt % of said mass to the wt % of said surfactant may be at least 10, is suitably at least 15, is preferably at least 20, is more preferably at least 25, and especially is at least 40. The ratio may be less than 200, suitably is less than 150, preferably is less than 100, more preferably is less than 75. In a preferred embodiment, the ratio is in the range 25 to 100, more preferably 25 to 75.

The viscosity of the first mixture may be in the range 100-150 poise, measured at 100 s⁻¹.

In step (A) said surface active agent and said contaminated material are mixed, suitably gently, thereby to reduce the risk of forming a colloidal dispersion of the contaminated material, for example drill cuttings. Mixing as aforesaid is preferably undertaken for between 10 minutes and 1 hour. It is believed that, during mixing, a hydrophobic moiety of the surface active agent interacts with the hydrocarbon.

Said surface active agent suitably includes a hydrophobic moiety which has an aromatic ring system, for example comprising fused rings. Said hydrophobic moiety is preferably non-polar. Said hydrophobic moiety preferably does not incorporate any electronegative atom or group. Said hydrophobic moiety is preferably oil soluble.

Said surface active agent suitably includes a hydrophilic moiety which is preferably an ionic moiety. Said surface active agent is preferably an anionic surfactant. A said hydrophilic moiety preferably includes an —SO₃— moiety. Said hydrophilic moiety may comprise a sodium salt. Said hydrophilic moiety preferably comprises a sulphonate moiety. Said hydrophilic moiety may be pendent from an aromatic, for example phenyl moiety.

The molecular weight of the surface active agent may be in the range 300 to 500 Daltons.

Said surfactant is preferably wholly soluble in oil of the type contaminating the solid material.

Said surfactant is preferably a sodium salt of a sulphonated petroleum fraction.

Said contaminated material contacted in step (A) may comprise 10 to 20 wt % of hydrocarbon contaminant and 80 to 90 wt % of drill cuttings.

Said first mixture contacted in step (B) preferably comprises 100 parts by weight (pbw) of solid material; 10 to 20 pbw of hydrocarbon(s); up to 5 pbw of said surface active agent; and up to 10 pbw water.

Said carrier formulation contacted with said first mixture in step (B) preferably includes a carrier which is arranged to interact with a hydrophilic moiety of said surface active material. This may be implied by virtue of a reduction in viscosity of the first mixture on contact with said carrier formulation. Said carrier preferably includes a polar moiety. Said carrier may include a cationic moiety. Said cationic moiety may be part of a heteroaromatic moiety. Said polar and/or cationic moiety may interact with said hydrophilic moiety of the surface active agent.

Said carrier preferably includes a quaternary ammonium moiety. Said quaternary ammonium moiety may be part of an heteroaromatic moiety for example a pyridinium moiety.

Said carrier is preferably a first polymeric material. Said first polymeric material preferably includes a multiplicity of cationic moieties as described.

Said first polymeric material is preferably hydrophilic. It preferably includes hydroxy groups pendant from a polymeric chain. It is preferably a polyhydroxy polymeric material. It preferably incorporates a polyvinylalcohol moiety. It preferably comprises cross-linked polyvinylalcohol. Preferably, it comprises polyvinylalcohol cross-linked by a moiety which includes a polar moiety for example a quaternary ammonium moiety as described.

Said first polymeric material may include aldehyde moieties which may be a part of the aforesaid polar moiety.

Said carrier formulation preferably comprises a said first polymeric material which comprises a second polymeric material cross-linked by a third polymeric material, wherein said third polymeric material comprises:

(i) a third polymeric material having a repeat unit of formula

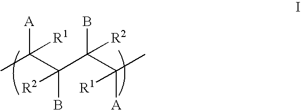

wherein A and B are the same or different, are selected from optionally-substituted aromatic and heteroaromatic groups and at least one comprises a relatively polar atom or group and R¹ and R² independently comprise relatively non-polar atoms or groups; or
(ii) a third polymeric material prepared or preparable by providing a compound of general formula

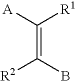

wherein A, B, R¹ and R² are as described above, in an aqueous solvent and causing the groups C═C in said compound to react with one another to form said third polymeric material.

Said first polymeric material could be formed in situ after the contaminated material and surface active agent are initially brought into contact, by contacting contaminated material with a precursor formulation comprising said third and second polymeric materials so that the third and second polymeric materials react after initial contact with the contaminated material.

Preferably, however, said third and second polymeric materials are reacted to form said first polymeric material prior to contact with said contaminated material.

Said carrier formulation is preferably aqueous and may include at least 85 wt %, perhaps at least 90 wt %, especially at least 95 wt % water. The amount of water may be less than 98 wt %.

Prior to step (B), said method preferably comprises selecting a said third polymeric material; selecting a second polymeric material which includes a functional group which is able to react in the presence of said third polymeric material to form said first polymeric material; and causing the formation of said first polymeric material by a reaction involving said third and second polymeric materials.

The ratio of the wt % of said third polymeric material to the wt % of said second polymeric material selected for preparation of said first polymeric material is suitably less than 0.1, preferably less than 0.08, more preferably less than 0.06, especially less than 0.05. Said ratio may be at least 0.01, preferably at least 0.02, more preferably at least 0.03, especially at least 0.035. Preferably, the ratio is selected so that a gel is not formed by interaction of the second and third polymeric materials.

The sum of the wt % of the third and second polymeric materials selected for preparation of said first polymeric material may be at least 2 wt %, preferably at least 3 wt %, more preferably at least 4 wt %, based on the total weight of the carrier formulation. The sum may be less than 15 wt %, preferably less than 10 wt %, more preferably less than 8 wt %, especially less than 6 wt %.

Suitably, the amounts of “third polymeric material” and “second polymeric material” described refer to the sum of the amounts of third polymeric materials (if more than one type is provided) and the sum of the amounts of second polymeric materials (if more than one type is provided). Preferably, however, only one type of third polymeric material is included.

Water for use in the carrier formulation may be derived from any convenient source. It may be potable water, surface water, sea water, aquifer water, deionised production water and filtered water derived from any of the aforementioned sources. The water may be treated so that it is suitable for use in the method. For example, it may be treated by addition of oxygen scavengers, biocides, corrosion inhibitors, scale inhibitors, anti-foaming agents and flow improvers. Sea water and/or water from other sources may be deoxygenated and/or desulphonated.

In the preparation of said first polymeric material a catalyst is preferably provided for catalysing the reaction of the third and second polymeric materials. Said catalyst is preferably a protic acid. Said acid preferably has an acid dissociation constant value of greater than 10⁻⁶, more preferably greater than 10⁻⁴ and, especially, greater than 10⁻². A precursor formulation which includes said third and second polymeric materials suitably includes less than 5 wt %, preferably less than 2 wt %, more preferably less than 1 wt %, especially less than 0.5 wt % of catalyst.

The pH of said carrier formulation immediately prior to contact with said first mixture in step (B) is suitably less than 7, preferably less than 5, more preferably less than 3. The pH is preferably greater than 1, more preferably greater than 2.

In the materials described above, A and/or B could be multi-cyclic aromatic or heteroaromatic groups. Preferably, A and B are independently selected from optionally-substituted five or more preferably six-membered aromatic and heteroaromatic groups. Preferred heteroatoms of said heteroaromatic groups include nitrogen, oxygen and sulphur atoms of which oxygen and especially nitrogen, are preferred. Preferred heteroaromatic groups include only one heteroatom. Preferably, a or said heteroatom is positioned furthest away from the position of attachment of the heteroaromatic group to the polymer backbone. For example, where the heteroaromatic group comprises a six-membered ring, the heteroatom is preferably provided at the 4-position relative to the position of the bond of the ring with the polymeric backbone.

Preferably, A and B represent different groups. Preferably, one of A or B represents an optionally-substituted aromatic group and the other one represents an optionally-substituted heteroaromatic group. Preferably A represents an optionally-substituted aromatic group and B represents an optionally-substituted heteroaromatic group especially one including a nitrogen heteroatom such as a pyridinyl group.

Unless otherwise stated, optionally-substituted groups described herein, for example groups A and B, may be substituted by halogen atoms, and optionally substituted alkyl, acyl, acetal, hemiacetal, acetalalkyloxy, hemiacetalalkyloxy, nitro, cyano, alkoxy, hydroxy, amino, alkylamino, sulphinyl, alkylsulphinyl, sulphonyl, alkylsulphonyl, sulphonate, amido, alkylamido, alkylcarbonyl, alkoxycarbonyl, halocarbonyl and haloalkyl groups. Preferably, up to 3, more preferably up to 1 optional substituents may be provided on an optionally substituted group.

Unless otherwise stated, an alkyl group may have up to 10, preferably up to 6, more preferably up to 4 carbon atoms, with methyl and ethyl groups being especially preferred.

Preferably, A and B each represent polar atoms or group—that is, there is preferably some charge separation in groups A and B and/or groups A and B do not include carbon and hydrogen atoms only.

Preferably, at least one of A or B includes a functional group which can undergo a condensation reaction, for example on reaction with said second polymeric material. Preferably, A includes a said functional group which can undergo a condensation reaction.

Preferably, one of groups A and B includes an optional substituent which includes a carbonyl or acetal group with a formyl group being especially preferred. The other one of groups A and B may include an optional substituent which is an alkyl group, with an optionally substituted, preferably unsubstituted, C₁₋₄ alkyl group, for example a methyl group, being especially preferred.

Preferably, A represents a group, for example an aromatic group, especially a phenyl group, substituted (preferably at the 4-position relative to polymeric backbone when A represents an optionally-substituted phenyl group) by a formyl group or a group of general formula

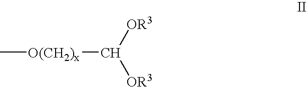

where x is an integer from 1 to 6 and each R³ is independently an alkyl or phenyl group or together form an alkalene group.

Preferably, B represents an optionally-substituted heteroaromatic group, especially a nitrogen-containing heteroaromatic group, substituted on the heteroatom with a hydrogen atom or an alkyl or aralkyl group. More preferably, B represents a group of general formula

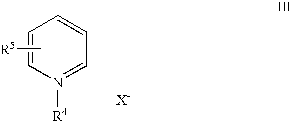

wherein R⁴ represents a hydrogen atom or an alkyl or aralkyl group, R⁵ represents a hydrogen atom or an alkyl group and X⁻ represents a strongly acidic ion.

Preferably, R¹ and R² are independently selected from a hydrogen atom or an optionally-substituted, preferably unsubstituted, alkyl group. Preferably, R¹ and R² represent the same atom or group. Preferably, R¹ and R² represent a hydrogen atom.

Preferred third polymeric materials may be prepared from any of the compounds described on page 3 line 8 to line 39 of GB2030575B by the method described in WO98/12239 and the contents of the aforementioned documents are incorporated herein by reference.

Said third polymeric material may be of formula

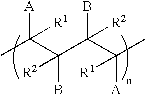

wherein A, B, R¹ and R² are as described above and n is an integer. Integer n is suitably 10 or less, preferably 8 or less, more preferably 6 or less, especially 5 or less. Integer n is suitably at least 1, preferably at least 2, more preferably at least 3. Preferably, formation of said first polymeric material from said third and second polymeric materials involves a condensation reaction. Preferably, formation of said first polymeric material involves an acid catalysed reaction. Preferably, said third and second polymeric materials include functional groups which are arranged to react, for example to undergo a condensation reaction, thereby to form said first polymeric material. Preferably, said third and second polymeric materials include functional groups which are arranged to react for example to undergo an acid catalysted reaction thereby to form said first polymeric material.

Preferably, said second polymeric material includes a functional group selected from an alcohol, carboxylic acid, carboxylic acid derivative, for example an ester, and an amine group. Said second polymeric material preferably includes a backbone comprising, preferably consisting essentially of carbon atoms. The backbone is preferably saturated. Pendent from the backbone are one or more said functional groups described. Said polymer may have a number average molecular weight (Mn) of at least 10,000, preferably at least 50,000, especially at least 75,000. Mn may be less than 500,000, preferably less than 406,000. Said second polymeric material is preferably a polyvinyl polymer. Preferred second polymeric compounds include optionally substituted, preferably unsubstituted, polyvinylalcohol, polyvinylacetate, polyalkylene glycols, for example polypropylene glycol, and collagen (and any component thereof and of these polyvinylalcohol and/or polyvinylacetate based polymeric materials are preferred.

Preferably, said second polymeric is a vinyl alcohol copolymer.

Preferably, said second polymeric material includes at least one vinyl alcohol/vinyl acetate copolymer which suitably includes greater than 70%, preferably greater than 65%, more preferably greater than 75 wt % of vinyl alcohol moieties.

Preferably, said second polymeric material includes 15 to 25 wt % residual acetate moieties.

Said first polymeric material suitably includes a moiety of formula

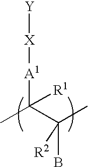

wherein R¹, R² and B are as described above, A¹ represents a residue of group A described above after the reaction involving said third and second polymeric materials, Y represents a residue of said second polymeric material after said reaction involving said third and second polymeric materials and X represents a linking atom or group extending between the residues of said third and second polymeric materials. In one preferred embodiment A¹ represents an optionally-substituted phenyl group, X represents a group

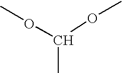

which is bonded via the oxygen atoms to a residue of said second polymeric material. For example, group X may be bonded to the polymer backbone of said second polymeric material.

Step (B), said second mixture is preferably mixed, suitably gently, to effect intimate contact between the components therein.

In step (C) may include allowing solid material to settle. The solid material may then be isolated, rinsed and discarded.

Preferably, after step (B) and before step (C), said second mixture is contacted with further water. The ratio of the weight of cuttings selected and used in step (A) to the weight of said further water is suitably less than 1, preferably less than 0.7, more preferably less than 0.5, especially less than 0.3. The ratio may be at least 0.05, preferably at least 0.1.

Suitably, the ratio of the weight of said further water to the weight of carrier formulation used in step (B) is at least 1, preferably at least 3, more preferably at least 4.5. The ratio may be less than 10.

The difference between the wt % of hydrocarbon contaminants in said solid material contacted in step (A) and that separated in step (C) may be at least 5 wt %, preferably at least 7 wt %, more preferably at least 9 wt %.

The ratio of the wt % of hydrocarbon contaminants in said solid material contacted in step (A) to that separated in step (C) may be at least 2, preferably at least 5, more preferably at least 9.

After step (C) of the method, the method preferably comprises, in a step (D), separating components which remain in said second mixture from one another. Step (D) preferably comprises separating said carrier together with any materials carried and/or associated therewith from other material (eg water) remaining in the second mixture. Step (D) preferably comprises separating a solid material which includes said carrier from a fluid. In step (D), said carrier may be caused to form a precipitate. Step (D) may include contacting the components remaining in the second mixture with a flocculating means which is suitably arranged to cause flocculation and/or precipitation of the carrier. The flocculated material may then be separated from other material by suitable means, for example filtration or centrifugation.

According to a second aspect of the invention, there is provided a method of cleaning a contaminated material comprising a solid material which is contaminated with a hydrocarbon, the method including the steps of:

(A*) contacting the contaminated material with a first polymeric material and/or with second and third polymeric materials of the types described above to prepare a mixture; and
(B*) separating solid material which is less contaminated than the contaminated material contacted in step (A) from other components in the mixture.

Said method of the second aspect may include any feature of the method of the first aspect.

Preferably, the method of the second aspect includes step (D) referred to above.

Preferably, the method of the second aspect includes step (A) referred to above.

Preferably, the method of the second aspect includes contacting said second mixture with further water after step (A*).

Preferably, the method of the second aspect includes contacting the contaminated material with a surface active agent as described in step (A) of the first aspect.

According to a third aspect of the invention, there is provided the use of a first polymeric material and/or second and third polymeric materials of the types described above in the decontamination of drill cuttings.

According to a fourth aspect of the invention, there is provided drill cuttings containing a trace of a first, second or third polymeric material as described herein.

Any feature of any aspect of any invention or embodiment described in any statement herein may be combined with any feature of any aspect of any other invention or embodiment described herein mutatis mutandis.

Specific embodiments of the invention will now be described, by way of example.

In general terms, oil contaminated drill cuttings (eg comprising up to 15 wt % oil) are contacted with an oil soluble surfactant with agitation, for example mixing, which is sufficiently gentle as not to destroy the granular structure of the cuttings more than necessary. It is believed that this causes the hydrophobic moiety of the surfactant to interact with the oil. Then, an aqueous polymer formulation comprising a polymer having polar and/or ionic functionality is added, followed by further gentle stirring. It is believed that this causes the hydrophilic moiety of the surfactant to interact with the polar and/or ionic functionality of the polymer. Next, an excess volume of water is added to the mixture, with gentle agitation. Thereafter, the mixture is allowed to settle, whereupon the cuttings sediment to the bottom of the receptacle in which the process is undertaken and the supernatant contains a colloidal suspension of particles (e.g. from clay particles which were initially a component of the drill cuttings) which comprise oil, surfactant and polymer. At this stage the cuttings; which may now comprise a substantially reduced amount of oil (about 1 wt %) may be separated from the supernatant by filtration. Thereafter, the supernatant may be treated with a flocculating agent to cause the colloidal particles to sediment. They too may then be separated from other components (mostly water) in the mixture in which they are contained.

The decontaminated cuttings may have sufficiently low oil content that it is permissible to discharge them into the sea. The sedimented colloidal particles can be stored and/or disposed of in an appropriate environmentally acceptable manner. The remainder of the mixture (mostly water) can also be pumped into the sea.

Further details on the process are included below:

The aqueous polymer formulation used comprises poly 1,4-di(4-(N-methylpyridinyl))-2,3-di(4-(1-formylphenyl)butylidene and poly(vinyl alcohol). These two polymers are caused to react in an acid catalysed reaction and the reaction product is able to interact with the oil-surfactant combination in the process.

Example 1 describes the preparation of the butylidene polymer.

### EXAMPLE 1

### Preparation of Poly(1,4-di(4-(N-methylpyridinyl))-2,3-di(4-(1-formylphenyl)butylidene

This was prepared as described in Example 1 of PCT/GB97/02529, the contents of which are incorporated herein by reference. In the method, an aqueous solution of greater than 1 wt % of 4-(4-formylphenylethenyl)-1-methylpyridinium methosulphonate (SbQ) is prepared by mixing the SbQ with water at ambient temperature. Under such conditions, the SbQ molecules form aggregates. The solution was then exposed to ultraviolet light. This results in a photochemical reaction between the carbon-carbon double bonds of adjacent 4-(4-formylphenylethenyl)-1-methylpyridinium methosulphate molecules (I) in the aggregate, producing a polymer, poly (1,4-di(4-(N-methylpyridinyl))-2,3-di(4-(1-formylphenyl)butylidene methosulphonate (II), as shown in the reaction scheme below. It should be appreciated that the anions of compounds I and II have been omitted in the interests of clarity.

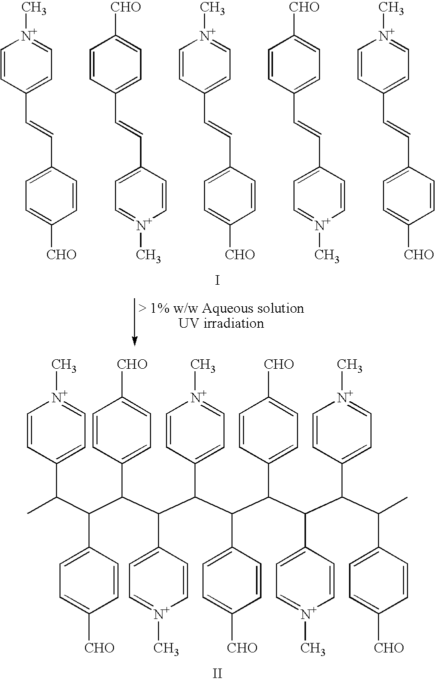

### EXAMPLE 2

### Preparation of Aqueous Polymer Formulation

A blend was prepared comprising 0.2 wt % of the butylidene polymer of Example 1 and 5 wt % of poly(vinylalcohol). Suitably, the poly(vinylalcohol) is added slowly with constant stirring to an aqueous solution of the butylidene polymer so as to disperse the poly(vinylalcohol). Final dissolution may be achieved by maintaining the solution at a temperature of 60° C. for a period of 6 hours

The solution is then acidified to pH 2 using hydrochloric acid and allowed to stand for a period of at least 30 minutes. It is preferably used shortly after this period has elapsed.

As a result of acidification and standing, the butylidene and the poly(vinylalcohol) polymers react according to the scheme below.

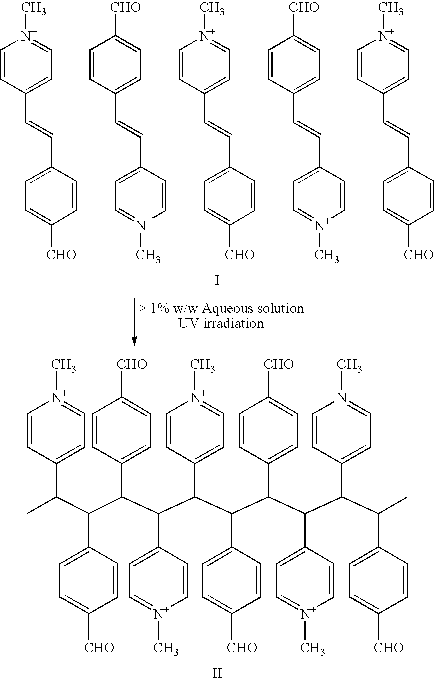

The aqueous polymer formulation then comprises a visco-elastic liquid having a viscosity of about 100 cp and is referred to hereinafter as “Solution A”.

### EXAMPLE 3

### Treatment of Drill Cuttings

100 g of contaminated drill cuttings were contacted with an oil-soluble surfactant namely a sodium salt of a sulphonated petroleum fraction (2 g) in a receptacle and gently mixed together using a paddle mixer for between 10 minutes and 1 hour. Then, 100 g of Solution A is added to the mixture with gentle stirring for at least 15 minutes

Next, an excess volume (eg 500-600 g) of water is added to the mixture with gentle agitation. The mixture is then allowed to stand and the cleaned cuttings gradually settle to the bottom of the receptacle. The supernatant comprises a colloidal suspension of particles. These particles are formed initially as a microemulsion of oil in water with the surfactant and the polymer formulation stabilising the emulsion. Fine clay particles in the drill cuttings, however, absorb oil so the supernatant comprises suspended clay particles which include absorbed oil. The colloidal particles are sedimented by addition of a flocculating agent (MAGNAFLOC (Trade Mark) obtained from Ciba Speciality Chemicals, Bradford, UK). The sedimented particles can then be isolated by filtration. They are found to contain of the order of 10 wt % of oil but constitute only of the order of 2-3 wt % of the total mass of the contaminated drill cuttings. Thus, most of the oil is concentrated into the small volume of the sedimented particles, with consequently greater ease of disposal.

Unless otherwise stated above, all of the steps described can be carried out at ambient temperature.

It will be appreciated that the process described can readily be applied on-site (offshore or on-shore) to drill cuttings.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of cleaning a contaminated material which comprises a solid material which is contaminated with a hydrocarbon, the method comprising the steps of:
(A) contacting the contaminated material with a surface active agent thereby to form a first mixture including said contaminated material and said surface active agent;
(B) contacting said first mixture with a carrier formulation to prepare a second mixture wherein said carrier formulation is arranged to interact with said surface active agent and/or said hydrocarbon;
(C) separating said solid material in said second mixture from other components in the second mixture, wherein said solid material which is separated contains a lower level of said hydrocarbon compared to that in said contaminated material contacted in step (A).

2. A method according to claim 1, wherein said contaminated material contacted in the method comprises drill cuttings produced when drilling for oil or gas.

3. A method according to claim 1, wherein said contaminated material is contaminated with a drilling fluid and/or with petroleum.

4. A method according to claim 1, wherein said contaminated material comprises at least 5 wt % of fluidic hydrocarbon(s).

5. A method according to claim 1, wherein said contaminated material comprises at least 5 wt % of oil.

6. A method according to claim 1, wherein, in the method, a mass of said contaminated material is selected and contacted with said surfactant and the ratio of the wt % of said mass to the wt % of said surfactant is at least 10 and is less than 200.

7. A method according to claim 1, wherein said surface active agent includes a hydrophobic moiety which has an aromatic ring system.

8. A method according to claim 1, wherein said surface active agent includes an hydrophilic moiety.

9. A method according to claim 1, wherein said surface active agent is an anionic surfactant.

10. A method according to claim 1, wherein said surface active agent is wholly soluble in oil of the type contaminating the solid material at 25° C.

11. A method according to claim 1, wherein said contaminated material contacted in step (A) comprises 10 to 20 wt % of hydrocarbon contaminant and 80 to 90 wt % of drill cuttings.

12. A method according to claim 1, wherein said first mixture contacted in step (B) comprises 100 parts by weight (pbw) of solid material, 10 to 20 pbw of hydrocarbon(s); up to 5 pbw of surface active agents; and up to 10 pbw water.

13. A method according to claim 1, wherein said carrier formulation contacted with said first mixture in step (B) includes a carrier which is arranged to interact with a hydrophilic moiety of said surface active material.

14. A method according to claim 1, wherein said carrier includes a polar moiety.

15. A method according to claim 1, wherein said carrier is a first polymeric material which includes a multiplicity of cationic moieties.

16. A method according to claim 15, wherein said first polymeric material includes hydroxyl groups pendent from a polymeric chain.

17. A method according to claim 1 wherein said carrier comprises a first polymeric material which incorporates a polyvinyl alcohol moiety.

18. A method according to claim 1, wherein said carrier formulation is aqueous and includes at least 85 wt % of water.

19. A method according to claim 1, wherein said carrier formulation comprises a said first polymeric material which comprises a second polymeric material cross-linked by a third polymeric material, wherein said third polymeric material comprises:
(i) a third polymeric material having a repeat unit of formula 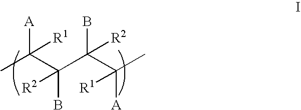
wherein A and B are the same or different, are selected from optionally-substituted aromatic and heteroaromatic groups and at least one comprises a relatively polar atom or group and R¹ and R² independently comprise relatively non-polar atoms or groups; or
(ii) a third polymeric material prepared or preparable by providing a compound of general formula 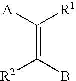
wherein A, B, R¹ and R² are as described above, in an aqueous solvent and causing the groups C═C in said compound to react with one another to form said third polymeric material.

20. A method according to claim 19, wherein said third and second polymeric materials are reacted to form said first polymeric material prior to contact with said contaminated material.

21. A method according to claim 19, wherein, prior to step (B), said method comprises selecting a said third polymer material; selecting a second polymeric material which includes a functional group which is able to react in the presence of said third polymeric material to form said first polymeric material; and causing the formation of said first polymeric material by a reaction involving said third and second polymeric materials.

22. A method according to claim 21, wherein the ratio of the wt % of said third polymeric material to the wt % of said second polymeric material selected for preparation of said first polymeric material is less than 0.1 and is at least 0.01.

23. A method according to claim 19, wherein one of A or B represents an optionally-substituted aromatic group and the other one represents an optionally-substituted heteroaromatic group.

24. A method according to claim 19, wherein R₁ and R₂ are independently selected from a hydrogen atom or an optionally-substituted alkyl group.

25. A method according to any claim 19, wherein said third polymeric material is of formula: 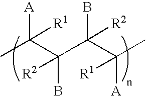
wherein n is an integer.

26. A method according to claim 19, wherein said second polymeric compound is selected from optionally-substituted polyvinyl alcohol, polyvinyl acetate and polyalkalene glycols.

27. A method according to claim 19, wherein said second polymeric material includes at least one vinyl alcohol/vinyl acetate copolymer.

28. A method according to claim 17, wherein in step (B) said second mixture is mixed to effect intimate contact between the components therein.

29. A method according to claim 28, wherein step (C) includes allowing solid material to settle.

30. A method according to claim 29, wherein after step (B) and before step (C), said second mixture is contacted with further water.

31. A method according to claim 29, wherein after step (C) the method comprises, in a step (D), separating components which remain in said second mixture from one another.

32. A method according to claim 31, wherein in step (D), said carrier is caused to form a precipitate.

33. A method of cleaning a contaminated material comprising a solid material which is contaminated with a hydrocarbon, the method including the steps of:
(A*) contacting the contaminated material with a first polymeric material and/or with second and third polymeric materials of the types described in any preceding claim to prepare a mixture; and
(B*) separating solid material which is less contaminated than the contaminated material contacted in step (A) from other components in the mixture.

34. The decontamination of drill cuttings by applying an effective amount of a first polymeric material and/or second and/or third polymeric materials according to the method as described in claim 1.

35. Drill cuttings containing a trace of polyvinylalcohol.
